(19) United States
(12) Patent Application Publication
(10) Pub. No.: US 2006/0251875 A1
(43) Pub. Date: Nov. 9, 2006

(54) Hermetic bio-inert coatings for bio-implants fabricated using atomic layer deposition

(75) Inventors: John A. Carlisle, Plainfield, IL (US); Michael J. Pellin, Naperville, IL (US); Jeffrey W. Elam, Elmhurst, IL (US); Jian Wang, Naperville, IL (US)

Correspondence Address: HARRY M. LEVY;EMRICH & DITHMAR, LLC, 125 SOUTH WACKER DRIVE, SUITE 2080, CHICAGO, IL, 60606-4401, US

(73) Assignee: The University of Chicago, Chicago, IL (US)

(21) Appl. No.: 11/123,602

(22) Filed: May 6, 2005

(51) Int. Cl. B32B 7/02

(52) U.S. Cl. 428/213; 428/221; 427/2.24; 428/336; 428/446; 428/698

(57) ABSTRACT

A biocompatible and bio-inert device is disclosed along with a method of making same. The device includes multiple layers of materials, preferably at least on layer of Al₂O₃, and an exterior amorphous layer, preferably TiO₂.

### CONTRACTUAL ORIGIN OF THE INVENTION

The United States Government has rights in this invention pursuant to Contract No. W-31-109-ENG-38 between the U.S. Department of Energy (DOE) and The University of Chicago representing Argonne National Laboratory.

### FIELD OF THE INVENTION

This invention relates to bioimplantable devices, particularly useful in humans.

### BACKGROUND OF THE INVENTION

This invention relates to a layered coasting and to a method of applying the coating to implantable devices. More specifically, this invention relates to a bio-inert coating and to a method of applying that coating to devices implantable in the human body. Devices which are implantable within the body must not trigger the body's immune reactions or poison the implant environment, i.e. they must be both bio-inert and bio-compatible. This is a particular problem for implants that are to have silicon-based microelectronic IC chips, where a thin film coating is yet to be found that renders the chips suitable for implantation. Silicon and silicon dioxide are both slightly soluble in water, and, for devices that must interact with the biological environment via electrical signals are subject to hydrolysis and other deleterious electrochemical reactions. Thus, it is particularly important that such devices be provided with an electrically insulating coating that is hermetic, and this is particularly true for retinal implants. What is needed is a method that can deposit a film at low temperatures as well as at higher temperatures, if required, that is electrically insulating and is continuous and substantially pin-hole free to provide a hermetic coating and whose surface chemistry makes it bio-inert in most biological situations.

Various methods are currently available to deposit hermetic bio-compatible coatings on various devices such as microelectrical mechanical devices (MEMS), semiconductors including integrated circuits (ICs) and the like. For instance, it is well known that AL₂O₃ (alumina) provides a hermetic coating which is bio-compatible and bio-inert in warm bloodied animals, such as humans. However, as taught in the Schulman et al. U.S. Pat. No. 6,043,437 and U.S. publication no. 2003/0087197 A1 published May 8, 2003, sputter deposition is one of the methods by which an alumina layer provides an insulative coating for a variety of devices implantable in humans. However, it has been determined that alumina coatings formed by sputter deposition are crystalline in nature and slowly corrode when used as implants in humans.

Accordingly, what is needed is a truly hermetic coating which is both bio-compatible and bio-inert for warm bloodied animals which when implanted in a warm bloodied animal, particularly a human, retains its hermetic properties.

### SUMMARY OF THE INVENTION

Accordingly, a principal object of the present invention is to provide an amorphous bio-compatible or bio-inert coating for use in warm bloodied animals which retains its hermetic properties after implantation.

Yet another object of the present invention is to use atomic layer deposition to provide multilayer hermetic bio-inert coatings for a variety of devices including MEMS semiconductor and integrated circuit containing devices or structures.

Another object of the invention is to provide a device biocompatible with a warm blooded animal, comprising a structure having a conformal coating thereon that is substantially pinhole free and is composed of one or more layers deposited by atomic layer deposition (ALD), the exterior layer of the conformal coating being selected from one or more of Al₂O₃ or TiO₂ or ZrO₂ or V₂O₅ or TiN or Si₃N₄ or SiC or Ti.

Still another object of the invention is to provide a device implantable in a human, comprising a structure containing an electrical component having a conformal coating thereon that is substantially pinhole free and has a thickness not less than about 100 Angstroms and is composed of one or more layers deposited by atomic layer deposition (ALD), the exterior layer of said conformal coating being selected from one or more of Al₂O₃ or TiO₂ or ZrO₂ or V₂O₅ or TiN or Si₃N₄ or SiC or Ti.

A further object of the invention is to provide a method of making a device biocompatible with a warm blooded animal, comprising providing a structure, depositing one or more amorphous layers on the substrate by atomic layer deposition (ALD) forming a conformal coating thereon that is substantially pinhole free, the exterior layer of the conformal coating being selected from one or more of Al₂O₃ or TiO₂ or ZrO₂ or V₂O₅ or TiN or Si₃N₄ or SiC or Ti.

The invention consists of certain novel features and a combination of parts hereinafter fully described, illustrated in the accompanying drawings, and particularly pointed out in the appended claims, it being understood that various changes in the details may be made without departing from the spirit, or sacrificing any of the advantages of the present invention.

### BRIEF DESCRIPTION OF THE DRAWINGS

For the purpose of facilitating an understanding of the invention, there is illustrated in the accompanying drawings a preferred embodiment thereof, from an inspection of which, when considered in connection with the following description, the invention, its construction and operation, and many of its advantages should be readily understood and appreciated.

FIG. 1 is a schematic illustration of the ALD process depositing a multilayer coating; and

FIG. 2 is a representation of cyclic voltamograms in 0.1 PBS (Phosphate Buffered Saline) for different metal oxide coatings.

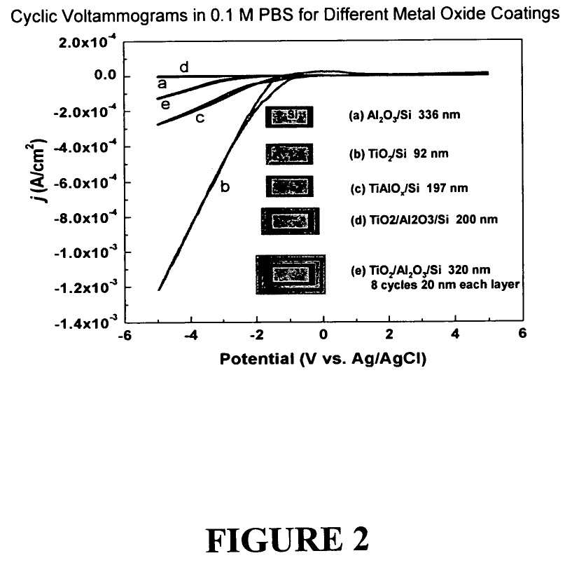

### DETAILED DESCRIPTION OF THE INVENTION

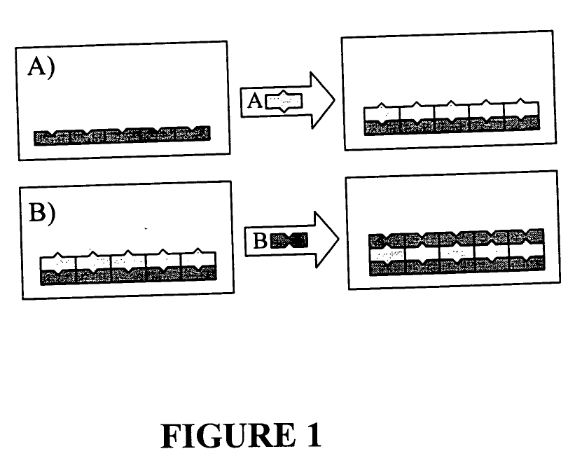

Atomic layer deposition (ALD) utilizes a pair of self limiting chemical reactions between gaseous precursor molecules and a solid surface to deposit films as illustrated in FIG. 1, see S. M. George, A. W. Ott, J. W. Klaus, J. Phys. Chem. 100 (1996) 13121, the disclosure of which is incorporated by reference. The notches in the starting substrate for reaction A represent discrete reactive surface sites. Exposing this surface to reactant A results in the self-terminating adsorption of a monolayer of A species. The resulting surface becomes the starting substrate for reaction B. Subsequent exposure to molecule B will cover the surface with a monolayer of B species. Consequently, one AB cycle deposits one monolayer of the compound AB and regenerates the initial substrate. By repeating the binary reaction sequence in an ABAB . . . fashion, a film of any thickness can be deposited with atomic layer precision. The saturation of the individual A and B reactions in each AB cycle ensures that the deposited films are dense, smooth and pinhole free. Moreover, diffusion of the gaseous precursor molecules into voids and shadowed regions of the surface allows materials with complex topographies to be coated conformally. As an example, consider the following binary reaction sequence for the ALD of Al₂O₃:
A) Al—OH*+Al(CH₃)₃→Al—O—Al(CH₃)₂*+CH₄ (1)
B) Al—O—Al—CH₃*+H₂O→Al—O—Al—OH*+CH₄ (2)
In these reactions, the asterisks designate the surface species. In reaction A, the substrate surface is initially covered with hydroxyl (OH) groups. The hydroxyl groups react with trimethyl aluminum (Al(CH₃)₃, TMA) to deposit a monolayer of aluminum atoms that are terminated by methyl (CH₃) species releasing methane (CH₄) as a reaction product. Because TMA is inert to the methyl-terminated surface, further exposure to TMA yields no additional growth beyond one monolayer. Subsequent exposure of this new surface to water regenerates the initial hydroxyl-terminated surface and releases methane. The net effect of one AB cycle is to deposit one monolayer of Al₂O₃ on the surface.

Binary reaction sequences exist for depositing a wide variety of oxide, carbide, nitride, metallic, and other materials. Precusor chemicals and typical deposition temperatures for the biocompatible materials relevant to this invention are given in Table 1. Other precursor combinations and deposition temperatures may be used to deposit these materials.

TABLE 1
Table 1: Biocompatible films deposited by ALD
along with A and B precursor molecules
and typical deposition temperatures.

| Biocompatible ALD | Precursor | Precursor | Typical Deposition |
|---|---|---|---|
| Film | “A” | “B” | Temperature (° C.) |
| Al₂O₃ | Al(CH₃)₃ | H₂O | 200 |
| TiO₂ | TiCl₄ | H₂O | 200 |
| V₂O₅ | VO(OC₃H₇)₃ | H₂O₂ | 100 |
| ZrO₂ | ZrCl₄ | H₂O | 300 |
| TiN | TiCl₄ | NH₃ | 400 |
| Si₃N₄ | SiCl₄ | NH₃ | 400 |
| SiO₂ | SiCl₄ | H₂O | 400 |
| Ti | TiCl₄ | H-atom | 100 |
| SiC | SiH₂Cl₂ | C₂H₂ | 850 |

### EXAMPLES

A series of 5 coatings (a-e) were prepared in a viscous flow ALD reactor using a continuous flow of 360 sccm ultrahigh purity nitrogen at a pressure of 1 Torr and a deposition temperature of 200° C. The Al₂O₃ layers were prepared using alternating exposures to trimethyl aluminum (TMA) and water while the TiO₂ layers used titanium tetrachloride (TiCl₄) and water (H₂O). The TMA, TiCl₄ and H₂O precursor exposures had a pressure of ˜0.1 Torr and a duration of 0.3 s and purge periods of 1.5 s were used in between each exposure. In each case, the precursor exposure cycles were repeated to achieve the desired Al₂O₃ or TiO₂ layer thickness. Film a is pure Al₂O₃ with a thickness of 336 nm. Film b is pure TiO₂ with a thickness of 92 nm. Film c is an alloy of TiAlOₓ with a thickness of 197 nm prepared using the pulse sequence: TMA/H₂O/TiCl₄/H₂O . . . Film d consists of one Al₂O₃ layer with a thickness of 100 nm followed by a layer of TiO₂ with a thickness of 100 nm so that the film has an overall thickness of 200 nm. Film e consists of 16 layers, each 20 nm, that are comprised of a stack of alternating Al₂O₃ and TiO₂ layers. The figure shows current versus voltage results measured for a series of ALD films deposited onto Si substrates and then immersed into 0.1 M PBS (Phosphate Buffered Saline) solutions. In this figure, lower currents (A/cm2) correspond to better quality hermetic coatings because less current flows through the coating. Film d showed the best performance.

As set forth in the Table 1 and Examples above, ALD deposition temperatures vary with the material that is being deposited. Certain of the materials can be deposited at ambient temperatures such as alumina. Other coatings, however, require much higher deposition temperatures such as silicon carbide. Nevertheless, a wide variety of materials can be deposited by ALD and of those which are bio-compatible or bio-inert, the above Table lists most of them. In general, in order to be pin-hole free, aluminum oxide coatings should be about 100 Angstroms in thickness and in general, for a useful implantable device the coatings will generally be less than about 10 microns in thickness. It is known that titanium dioxide is both biocompatible and bio-inert in human beings and therefore, it is preferred that the exterior coating for a device which includes a MEMS, semiconductors or integrated circuits has as an exterior coating, titanium dioxide. Nevertheless, a variety of other materials may be useful for the exterior coating and these include alumina, titanium, zirconia, vanadia, titanium nitride, silica nitride, silicona carbide or titanium. Not all of these materials are preferred and some of them such as titanium metal are difficult to deposit using ALD. Nevertheless, these materials are included in the invention since conformal coatings with any one or more of these materials as an exterior layer will suffice.

While the invention has been particularly shown and described with reference to a preferred embodiment hereof, it will be understood by those skilled in the art that several changes in form and detail may be made without departing from the spirit and scope of the invention.

1. A device biocompatible with a warm blooded animal, comprising a structure having a conformal coating thereon that is substantially pinhole free and is composed of one or more layers deposited by atomic layer deposition (ALD), the exterior layer of said conformal coating being selected from one or more of Al₂O₃ or TiO₂ or ZrO₂ or V₂O₅ or TiN or Si₃N₄ or SiC or Ti.

2. The device of claim 1, wherein at least one of said layers is about 1 Angstrom in thickness.

3. The device of claim 1, wherein at least one of said layers is deposited at a temperature of less than about 400° C.

4. The device of claim 1, wherein at least one of said layers is deposited at a temperature of not more than about 900° C.

5. The device of claim 1, wherein at least one of said layers is deposited at a temperature of less than about 100° C.

6. The device of claim 1, wherein at least one of said layers is deposited at substantially ambient temperature.

7. The device of claim 1, wherein said conformal coating has a thickness in the range of from about 100 Angstroms to about 10 microns.

8. The device of claim 1, wherein said conformal coating contains multiple layers at least one of which is Al₂O₃.

9. The device of claim 1, wherein the exterior layer of said conformal coating is substantially bio-inert in a human.

10. The device of claim 1, wherein the exterior layer of said conformal coating is TiO₂.

11. The device of claim 1, wherein said structure contains one or more of Si, Au, Ag, Pt, Pd, Ta, Cr, W, Ta, SiO₂, Al₂O₃, TiN, TaN, Si₃N₄, and polymers

12. A device implantable in a human, comprising a structure containing an electrical component having a conformal coating thereon that is substantially pinhole free and has a thickness not less than about 100 Angstroms and is composed of one or more layers deposited by atomic layer deposition (ALD), the exterior layer of said conformal coating being selected from one or more of Al₂O₃ or TiO₂ or ZrO₂ or V₂O₅ or TiN or Si₃N₄ or SiC or Ti.

13. The device of claim 12, wherein said electrical component includes a micro electrical mechanical (MEMS) device.

14. The device of claim 12, wherein said electrical component includes a semiconductor.

15. The device of claim 12, wherein said conformal coating has an exterior layer of TiO₂ with a thickness up to about 10 microns.

16. The device of claim 12, wherein ALD depositions occur at temperatures in the range of from about ambient to about 900° C.

17. The device of claim 12, wherein said structure contains one or more of Si, Au, Ag, Pt, Pd, Ta, Cr, W, Ta, SiO₂, Al₂O₃, TiN, TaN, Si₃N₄, and polymers

18. A method of making a device biocompatible with a warm blooded animal, comprising providing a structure, depositing one or more amorphous layers on the structure by atomic layer deposition (ALD) forming a conformal coating thereon that is substantially pinhole free, the exterior layer of the conformal coating being selected from one or more of Al₂O₃ or TiO₂ or ZrO₂ or V₂O₅ or TiN or Si₃N₄ or SiC or Ti.

19. The method of claim 18, wherein the structure includes a layer of Al₂O₃ and an exterior layer of TiO₂.

20. The method of claim 19, wherein the Al₂O₃ layer has a thickness between about 100 Angstroms and 5 microns.
